(19) United States
(12) Patent Application Publication
(10) Pub. No.: US 2024/0399906 A1
(43) Pub. Date: Dec. 5, 2024

(54) VEHICLE CHARGING DEVICE

(71) Applicants: INVENTEC (PUDONG) TECHNOLOGY CORPORATION, Shanghai (CN); INVENTEC CORPORATION, Taipei City (TW)

(72) Inventor: Chi-Cheng HSIAO, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/235,494

(22) Filed: Aug. 18, 2023

(30) Foreign Application Priority Data
Jun. 2, 2023 (CN) 202310651053.9

(51) Int. Cl. B60L 53/30; B60L 53/16

(52) U.S. Cl. CPC B60L 53/30; B60L 53/16

(57) ABSTRACT

A vehicle charging device includes a base, a circuit board, a plurality of supporting pillars and a plurality of conductors. The base has an accommodating space. The circuit board is located in the accommodating space. The plurality of supporting pillars are located in the accommodating space, and are connected to the base. Each of the plurality of conductors includes a contact portion and a connection portion. The plurality of contact portions are disposed on the base. The plurality of contact portions are located outside the accommodating space. The plurality of connection portions are connected to the plurality of contact portions, respectively. The plurality of connection portions penetrate through the base. The plurality of connection portions are partially located in the accommodating space. The plurality of connection portions are electrically connected to the circuit board.

### CROSS-REFERENCE TO RELATED APPLICATIONS

This non-provisional application claims priority under 35 U.S.C. § 119(a) on Patent Application No(s). 202310651053.9 filed in China, on Jun. 2, 2023, the entire contents of which are hereby incorporated by reference.

### BACKGROUND OF THE INVENTION

### Technical Field of the Invention

The invention relates to a vehicle charging device, more particularly to a vehicle charging device with supporting pillars.

### Description of the Related Art

Recently, an awareness of environmental protection has risen, such that an electric vehicle using electric energy as a driving energy has been more and more popular. Compared with a fuel vehicle consuming fossil fuel quickly and emitting a large amount of carbon dioxide and other polluting gases during driving to cause global warming and air pollution, the electric vehicle has advantages of no fossil fuel consumption and less air pollution. Thus, the electric vehicle does not cause excessive damage to the environment.

When the battery of the electric vehicle is exhausted, a driver may charge the electric vehicle via a vehicle charging device. Generally, types of the vehicle charging device include a vehicle charging pile and a vehicle charging pad. The conventional vehicle charging pad charges the electric vehicle via wireless charging. Due to a slow charging speed of the wireless charging, manufacturers develop a vehicle contact charging pad to increase the charging speed. The vehicle contact charging pad needs to be able to bear a weight of the electric vehicle while charging the electric vehicle. However, a structural strength of the conventional vehicle contact charging pad is insufficient. When the electric vehicle is charged via the vehicle contact charging pad, the vehicle contact charging pad may be damaged due to the weight of the electric vehicle, such that the vehicle contact charging pad cannot charge the electric vehicle. Therefore, how to improve the structural strength of the vehicle charging device is an important issue to be solved.

### SUMMARY OF THE INVENTION

The invention provides a vehicle charging device having improved structural strength.

One embodiment of the invention provides a vehicle charging device including a base, a circuit board, a plurality of supporting pillars and a plurality of conductors. The base has an accommodating space. The circuit board is located in the accommodating space. The plurality of supporting pillars are located in the accommodating space, and are connected to the base. Each of the plurality of conductors includes a contact portion and a connection portion. The plurality of contact portions are disposed on the base. The plurality of contact portions are located outside the accommodating space. The plurality of connection portions are connected to the plurality of contact portions, respectively. The plurality of connection portions penetrate through the base. The plurality of connection portions are partially located in the accommodating space. The plurality of connection portions are electrically connected to the circuit board.

According to the vehicle charging device disclosed by the above embodiments, since the weight of the electric vehicle is distributed between the conductors and the supporting pillars, the conductors may not be damaged due to bearing excessive weight.

Therefore, the structural strength of the vehicle charging device can be improved.

### BRIEF DESCRIPTION OF THE DRAWINGS

The present invention will become more fully understood from the detailed description given herein below and the accompanying drawings which are given by way of illustration only and thus are not limitative of the present invention and wherein:

FIG. 1 is a perspective view of a vehicle charging device in accordance with an embodiment of the invention;

FIG. 2 is an exploded view of the vehicle charging device in FIG. 1; and

FIG. 3 is a cross-sectional view of the vehicle charging device in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present invention, such as technical and scientific terms, have its own meanings and can be comprehended by those skilled in the art, unless the terms are additionally defined in the present invention. That is, the terms used in the following paragraphs should be read on the meaning commonly used in the related fields and will not be overly explained, unless the terms have a specific meaning in the present invention.

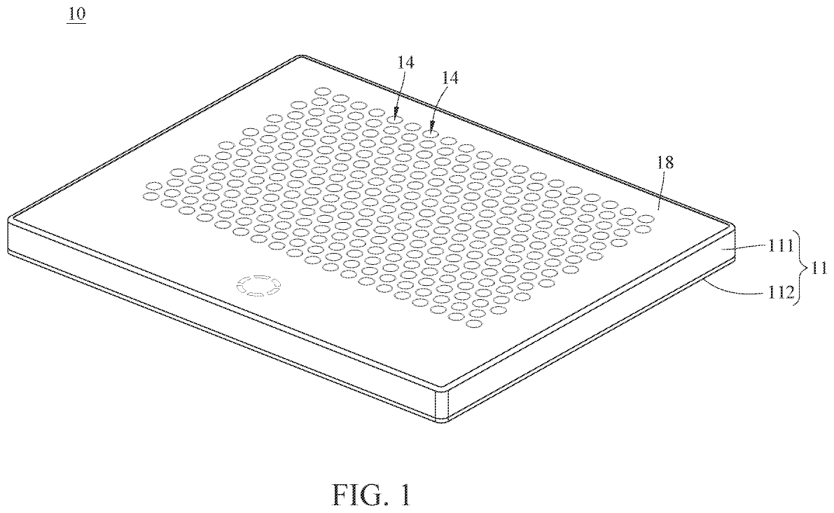

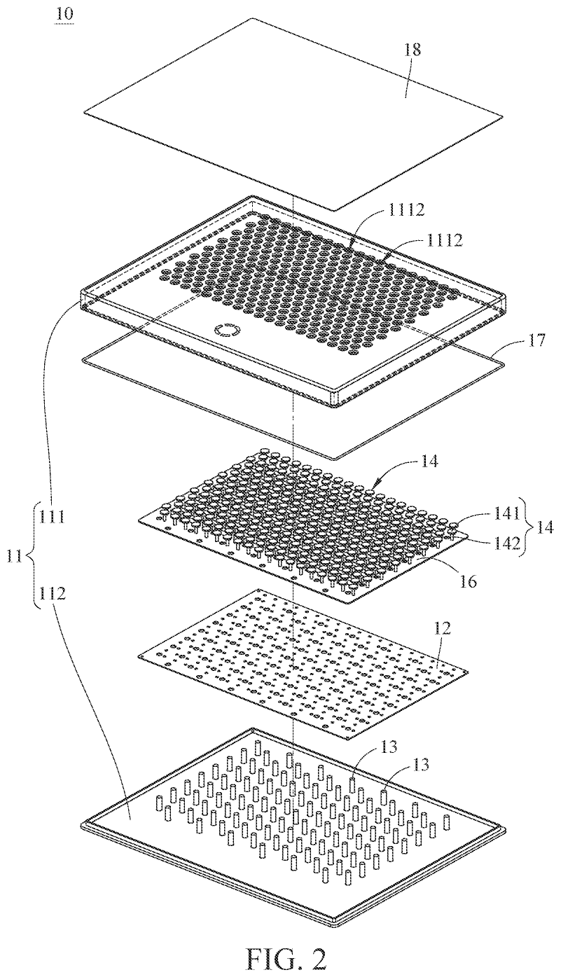

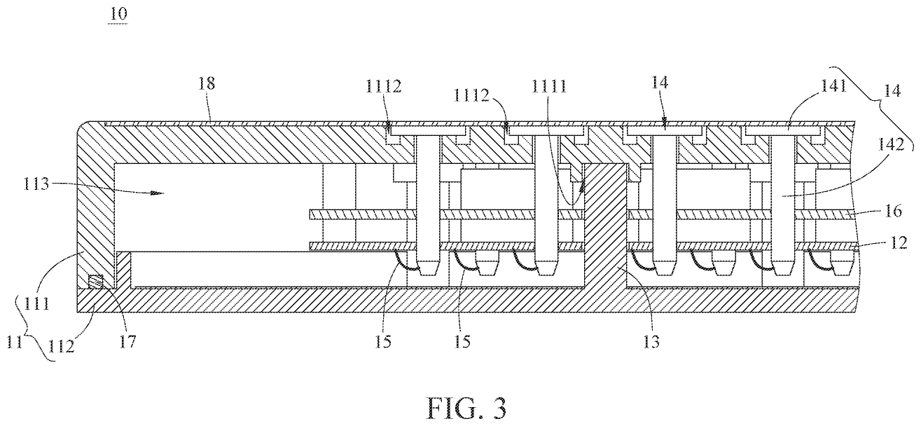

Please refer to FIG. 1 to FIG. 3, where FIG. 1 is a perspective view of a vehicle charging device 10 in accordance with an embodiment of the invention, FIG. 2 is an exploded view of the vehicle charging device 10 in FIG. 1, and FIG. 3 is a cross-sectional view of the vehicle charging device 10 in FIG. 1.

In this embodiment, the vehicle charging device 10 includes a base 11, a circuit board 12, a plurality of supporting pillars 13, a plurality of conductors 14 and a plurality of flexible cables 15. The base 11 includes a cover 111 and a bottom plate 112. The cover 111 is disposed on the bottom plate 112, such that the bottom plate 112 and the cover 111 together surround and form an accommodating space 113. The circuit board 12 is located in the accommodating space 113. The supporting pillars 13 are located in the accommodating space 113. The cover 111 includes a plurality of mounting recesses 1111. Ends of the supporting pillars 13 and the bottom plate 112 are, for example, integrally formed as a single piece, and the other ends of the supporting pillars 13 are mounted in the mounting recesses 1111, respectively. The bottom plate 112 and the supporting pillars 13 are made of, for example, metal material.

The conductors 14 are made of, for example, copper, and are movably disposed on the base 11 and the circuit board 12. Accordingly, when an electric vehicle (not shown) moves to the vehicle charging device 10 to be supported by the vehicle charging device 10 or the electric vehicle leaves the vehicle charging device 10, the conductors 14 may be moved up and down slightly with a change of a weight born by the vehicle charging device 10. Each of the conductors 14 includes a contact portion 141 and a connection portion 142. A surface of the cover 111 facing away from the bottom plate 112 has a plurality of accommodating recesses 1112. The contact portions 141 are located outside the accommodating space 113, and are disposed in the accommodating recesses 1112, respectively. The contact portions 141 are flush with the accommodating recesses 1112, respectively. The connection portions 142 are connected to the contact portions 141, respectively, and penetrate through the cover 111 and the circuit board 12 to be located in the accommodating space 113. Ends of the flexible cables 15 are electrically connected to the circuit board 12, and another ends of the flexible cables 15 are electrically connected to the connection portions 142, respectively.

In this embodiment, when the vehicle charging device 10 supports the electric vehicle and is electrically connected to the electric vehicle, the conductors 14 can be electrically connected to the circuit board 12 via the flexible cables 15. In addition, a bending or a vibration caused by the base 11 of the vehicle charging device 10 when supporting the electric vehicle can be resisted by the flexible cables 15 so as to improve a structural strength of the vehicle charging device 10, thereby preventing an abnormal charging function of the vehicle charging device 10 or a damage to the vehicle charging device 10.

In this embodiment, a shape of the supporting pillars 13 and a shape of the conductors 14 are, for example, cylindrical. The supporting pillars 13 and the conductors 14 are, for example, arranged in an array, respectively, and the supporting pillars 13 do not overlap with the conductors 14. That is, the supporting pillars 13 and the conductors 14 are in staggered arrangement. Accordingly, the weight of the electric vehicle can be distributed between the conductors 14 and the supporting pillars 13, so that the conductors 14 may not be damaged due to bearing excessive weight.

In this embodiment, the vehicle charging device 10 further includes a supporting plate 16. The supporting plate 16 is made of, for example, metal material. The supporting plate 16 is located in the accommodating space 113, and is disposed between the cover 111 and the circuit board 12. The connection portions 142 penetrate through the cover 111, the supporting plate 16 and the circuit board 12, respectively. The conductors 14 can be supported more stably via the supporting plate 16.

In this embodiment, the vehicle charging device 10 further includes a sealing member 17. The sealing member 17 is interposed between the bottom plate 112 and the cover 111 to seal the accommodating space 113. Accordingly, a sealing effect between the bottom plate 112 and the cover 111 can be improved via the sealing member 17 so as to meet waterproof and dustproof requirements of the vehicle charging device 10.

In this embodiment, the vehicle charging device 10 further includes a conductive film 18. The conductive film 18 covers the contact portions 141 of the conductors 14. Accordingly, a sealing effect between the cover 111 and the contact portions 141 can be improved via the conductive film 18 so as to meet waterproof and dustproof requirements of the vehicle charging device 10 without blocking an electrical communication between the vehicle charging device 10 and the electric vehicle.

In this embodiment, the contact portions 141 are disposed in the accommodating recesses 1112, respectively, and are flush with the accommodating recesses 1112, respectively, but the present invention is not limited thereto. In other embodiments, the contact portions are disposed in the accommodating recesses, respectively, and may be slightly higher or lower than the accommodating recesses, respectively.

According to the vehicle charging device disclosed by the above embodiments, since the weight of the electric vehicle is distributed between the conductors and the supporting pillars, the conductors may not be damaged due to bearing excessive weight. Therefore, the structural strength of the vehicle charging device can be improved.

In addition, the supporting pillars and the conductors are in staggered arrangement, and the supporting pillars do not overlap with the conductors. Thus, a path for dispersing the weight of the electric vehicle borne by the vehicle charging device is separated from a path for a power transmission to the electric vehicle from the vehicle charging device. Therefore, the structural strength of the vehicle charging device can be further improved.

Moreover, the conductors can be electrically connected to the circuit board via the flexible cables, and bending or vibration caused by the base of the vehicle charging device when supporting the electric vehicle can be resisted via the flexible cables. Therefore, the structural strength of the vehicle charging device can be further improved.

In the embodiment of the invention, the vehicle charging device of the invention can be applied to vehicle-mounted devices, such as autonomous vehicles, electric vehicles or semi-autonomous vehicles.

It will be apparent to those skilled in the art that various modifications and variations can be made to the present invention. It is intended that the specification and examples be considered as exemplary embodiments only, with the scope of the invention being indicated by the following claims and their equivalents.

What is claimed is:

1. A vehicle charging device, comprising:
a base, having an accommodating space;
a circuit board, located in the accommodating space;
a plurality of supporting pillars, located in the accommodating space and connected to the base; and
a plurality of conductors, wherein each of the plurality of conductors comprises a contact portion and a connection portion, the plurality of contact portions are disposed on the base, the plurality of contact portions are located outside the accommodating space, the plurality of connection portions are connected to the plurality of contact portions, respectively, the plurality of connection portions penetrate through the base, the plurality of connection portions are partially located in the accommodating space, and the plurality of connection portions are electrically connected to the circuit board.

2. The vehicle charging device according to claim 1, wherein the base comprises a bottom plate and a cover, the cover is disposed on the bottom plate, the bottom plate and the cover together surround and form the accommodating space, the cover comprises a plurality of mounting recesses, ends of the plurality of supporting pillars and the bottom plate are integrally formed as a single piece, and another ends of the plurality of supporting pillars are mounted in the plurality of mounting recesses, respectively.

3. The vehicle charging device according to claim 2, further comprising a sealing member, wherein the sealing member is interposed between the bottom plate and the cover to seal the accommodating space.

4. The vehicle charging device according to claim 2, wherein a surface of the cover facing away from the bottom plate has a plurality of accommodating recesses, and the plurality of contact portions of the plurality of conductors are located in the plurality of accommodating recesses, respectively.

5. The vehicle charging device according to claim 1, wherein the plurality of supporting pillars are arranged in an array, and the plurality of conductors are arranged in an array.

6. The vehicle charging device according to claim 5, wherein a shape of the plurality of supporting pillars and a shape of the plurality of conductors are cylindrical, and the plurality of supporting pillars do not overlap with the plurality of conductors.

7. The vehicle charging device according to claim 1, wherein the plurality of connection portions of the plurality of conductors penetrate through the circuit board.

8. The vehicle charging device according to claim 7, wherein the plurality of conductors are movably disposed on the base and the circuit board.

9. The vehicle charging device according to claim 8, further comprising a plurality of flexible cables, wherein ends of the plurality of flexible cables are electrically connected to the circuit board, and another ends of the plurality of flexible cables are electrically connected to the plurality of connection portions of the plurality of conductors, respectively.

10. The vehicle charging device according to claim 1, further comprising a conductive film, wherein the conductive film covers the plurality of contact portions of the plurality of conductors.
